(19) United States
(12) Patent Application Publication
(10) Pub. No.: US 2015/0366005 A1
(43) Pub. Date: Dec. 17, 2015

(54) Heating Using Carbon Nanotube-Based Heater Elements

(71) Applicants: Dawid JANAS, Cambridge (GB); Krzysztof Kazimierz KOZIOL, Cambridge (GB)

(72) Inventors: Dawid JANAS, Cambridge (GB); Krzysztof Kazimierz KOZIOL, Cambridge (GB)

(73) Assignee: Cambridge Enterprise Limited, Cambridge (GB)

(21) Appl. No.: 14/409,381

(22) PCT Filed: Jun. 21, 2012
(86) PCT No.: PCT/GB2012/051435

§ 371 Date: Dec. 18, 2014

(51) Int. Cl. H05B 3/14; H01C 17/28; H01C 17/06; H05B 3/34; H05B 3/08

(52) U.S. Cl. CPC H05B 3/145; H05B 3/34; H05B 3/08; H01C 17/06; H01C 17/28; H05B 2203/01; H05B 2203/013; H05B 2214/04

(57) ABSTRACT

A heater element for generating heat via Joule heating, the heater element having a layer of aligned carbon nanotubes and electrical terminals located to allow, in use, an electrical current to be passed along the layer of aligned carbon nanotubes. The direction of the electrical current in use is substantially perpendicular to the alignment direction of the aligned carbon nanotubes. Also disclosed is a method of manufacturing a heater element, the method including growing carbon nanotubes in a CVD reactor and forming the layer of aligned carbon nanotubes by pulling a carbon nanotube yarn from the CVD reactor, the alignment direction being the direction of pulling from the CVD reactor.

### BACKGROUND TO THE INVENTION

1. Field of the Invention

The present invention relates to the generation of heat via Joule heating using aligned carbon nanotube-based heater elements.

2. Related Art

Joule heating is the process by which heat is generated as a consequence of inelastic collisions between phonons and electrons accelerated in an electric field (Reference 1). Ramping up a bias voltage decreases the mean free path of an electron, the scattering rate intensifies and resistive losses come into sight (Reference 2). Up till now, highly resistive elements based on nichrome or kanthal are the primary choice and that has made them abundant in almost every heat generating appliance. Nevertheless, their electrical resistivity at room temperature, which is in the order of 1.0-1.5×10⁻⁶ Ω·m, is insufficient to consider any other geometry than strips or wires (Reference 3). Because of those constraints and their isotropic character one can only vary a wire length and diameter to reach the desired properties.

Carbon-based heating elements are known. For example, U.S. Pat. No. 5,444,327 discloses a heater formed of anisotropic pyrolytic graphite in which current is passed through the graphite in the c-direction. However, such heaters must be formed as monoliths and subsequently machined in order to form a desired shape.

### SUMMARY OF THE INVENTION

The present invention has been devised in order to address at least one of the above problems. Preferably, the present invention reduces, ameliorates, avoids or overcomes at least one of the above problems.

The present inventors have surprisingly found that aligned layers of carbon nanotubes can provide the basis for high performance electrical heaters. The present invention is based on this discovery.

Accordingly, in a first preferred aspect, the present invention provides a heater element for generating heat via Joule heating, the heater element having a layer of aligned carbon nanotubes and electrical terminals located to allow, in use, an electrical current to be passed along the layer of aligned carbon nanotubes, wherein the direction of the electrical current in use is substantially perpendicular to the alignment direction of the aligned carbon nanotubes.

In a second preferred aspect, the present invention provides a method of generating heat including the steps:

providing a heater element having a layer of aligned carbon nanotubes; and passing an electrical current along the layer of aligned carbon nanotubes to generate heat via Joule heating,

wherein the direction of the electrical current is substantially perpendicular to the alignment direction of the aligned carbon nanotubes.

In a third preferred aspect, the present invention provides a heater or an apparatus including a heater, wherein the heater includes a heating element according to the first aspect and power supply means for delivering an electrical current between the electrical terminals.

In a fourth preferred aspect, the present invention provides a method of manufacturing a heater element according to the first aspect, the method including growing carbon nanotubes in a CVD reactor and forming the layer of aligned carbon nanotubes by pulling a carbon nanotube yarn from the CVD reactor, the alignment direction being the direction of pulling from the CVD reactor.

The first, second, third and/or fourth aspect of the invention may have any one or, to the extent that they are compatible, any combination of the following optional features. Furthermore, the first, second, third and/or fourth aspect of the invention may be combined with each other.

In the following, the abbreviation CNT is used to denote carbon nanotube or carbon nanotubes.

As set out with respect to the fourth aspect, it is preferred that the carbon nanotube layer is formed by pulling a yarn of carbon nanotubes from a CVD reactor. The pulling direction typically corresponds to the alignment direction.

By “substantially perpendicular”, it is intended to include angles between the current direction and the CNT alignment direction of greater than 45°. More preferably, it is intended to include angles between the current direction and the CNT alignment direction of greater than 60°, still more preferably greater than 70°, still more preferably greater than 80°.

Preferably, the heater element is flexible. This allows it to be fixed with respect to a holder, for heating the holder. In some embodiments, the heater element may be provided in a roll form. In this case, the heater element may be unwound from the roll and conformed by the user to a specific task.

With respect to the fourth aspect, preferably the electrical terminals are affixed to the CNT layer in order to define the direction of the electrical current between them as substantially perpendicular to the CNT alignment direction. The step of affixing the electrical terminals may be done separately to the step of forming the CNT layer. In particular, it is envisaged that the step of formation of the CNT layer may be carried out by a manufacturer. Then, separately, the step of fixing the electrical terminals to the CNT layer may be carried out by an end user who selects or cuts the CNT layer to the desired size and/or shape and then affixes the electrical terminals in a suitable orientation to ensure the required angle between the CNT alignment direction and the electrical current direction.

The heater element may be used in applications where weight is of importance, e.g. in aerospace/aviation applications. For example, the heater element may be used for de-icing applications on aircraft.

The heater element may be used in applications where a small size for the heater is of importance, e.g. in microreactor heaters.

The heater element may be used in applications where speed of heating is of importance, e.g. in kinetic systems.

The nanotubes may comprise one or more selected from the group consisting of single wall carbon nanotubes (SWNTs), double wall carbon nanotubes (DWNTs) and multi wall carbon nanotubes (MWNTs).

Preferably the ratio between the resistivity perpendicular to the alignment direction and the resistivity parallel to the alignment direction is at least 2. More preferably this ratio is at least 3.

Preferably the density of the carbon nanotube layer is 0.1 gcm⁻³ or less.

Preferably the temperature coefficient of resistance between 50-300° C. is 0.001 K⁻¹ or less, more preferably 0.0005 K⁻¹ or less.

Further optional features of the invention are set out below.

### BRIEF DESCRIPTION OF THE DRAWINGS

Embodiments of the invention will now be described by way of example with reference to the accompanying drawings in which:

FIG. 1A shows a pictogram of synthesis of CNTs by the CVD direct spinning process.

FIG. 1B shows an SEM image of the horizontal alignment of CNTs.

FIG. 1C shows the dimensions and resistance values of CNT films specimens of parallel and perpendicular orientation. The plus and minus symbols indicate electrode attachment points.

FIG. 1D shows an SEM head-on image of a CNT film cross-section.

FIGS. 2A-D show electrothermal phenomena of free-standing CNT films.

FIG. 2A shows a pictogram of an experimental setup in which CNT films are supported between two quartz slides covered with aluminum tape and silver paint contacts.

FIG. 2B shows the fitting of heat exchange mechanisms governing heat exchange from the surface of a perpendicularly-aligned CNT film.

FIG. 2C shows emission from CNT films in the visible range at different temperatures.

FIG. 2D shows the permanent change of resistance during the first three runs of an orthogonally-aligned CNT film.

FIG. 3A shows the linear approximation of temperature coefficients of resistance for CNT films with current passed parallel to and orthogonally to the CNT alignment direction.

FIG. 3B shows the thermal stability over 8 h at different electrical power.

FIGS. 3C and 3D show the speed of heat response as measured from cooling down from a set temperature and heating up to this point for different aspect ratios of CNT films of perpendicular orientation (C) and parallel (D) to the alignment axis.

FIG. 4A demonstrates the performance of a CNT film heater in distilled water boiling.

FIG. 4B gives a size comparison of a CNT film heater and conventional immersion heater (left) and IR image of the element at 400° C. (right).

FIG. 4C shows a comparison of the CNT films performance at different wattage with a nichrome strip.

FIG. 4D shows the heating speed of a CNT film covering a mullite tube as compared with nichrome.

FIG. 5A illustrates the porosity of CNT films as measured by BET (liquid nitrogen, 77K, Tristar3000) by showing nitrogen isotherms of adsorption and desorption.

FIG. 5B shows the pore size distribution of CNT films as measured by BET (liquid nitrogen, 77K, Tristar3000).

FIG. 6A illustrates the method by which the CNT film is collected on a roll, cut and peeled off from an A4 sheet.

FIG. 6B shows a TEM (FEI Tecnai F20, FEG HRTEM) image of a bundle made of DWNTs.

FIG. 6C shows a Raman spectrum (λ=633 nm, 2 mW, Renishaw Raman RM2000) in normal and orthogonal direction of laser polarization to the alignment of CNT films.

FIG. 7A shows the relation between set electric power and surface temperature of an orthogonally aligned CNT film in the course of three runs.

FIG. 7B shows the permanent change of resistance during the first runs of a normally-aligned CNT film.

FIGS. 8A-C show SEM (JEOL 6340F FEG-SEM) head-on images of CNT film heather-like scission point with lost alignment at (A) 800× (B) 200× and (C) 10,000× magnifications.

FIG. 9 shows the experimental setup for mullite tube heating. CNT films were further substituted by a nichrome strip as reference.

### DETAILED DESCRIPTION OF THE PREFERRED EMBODIMENTS, AND FURTHER OPTIONAL FEATURES OF THE INVENTION

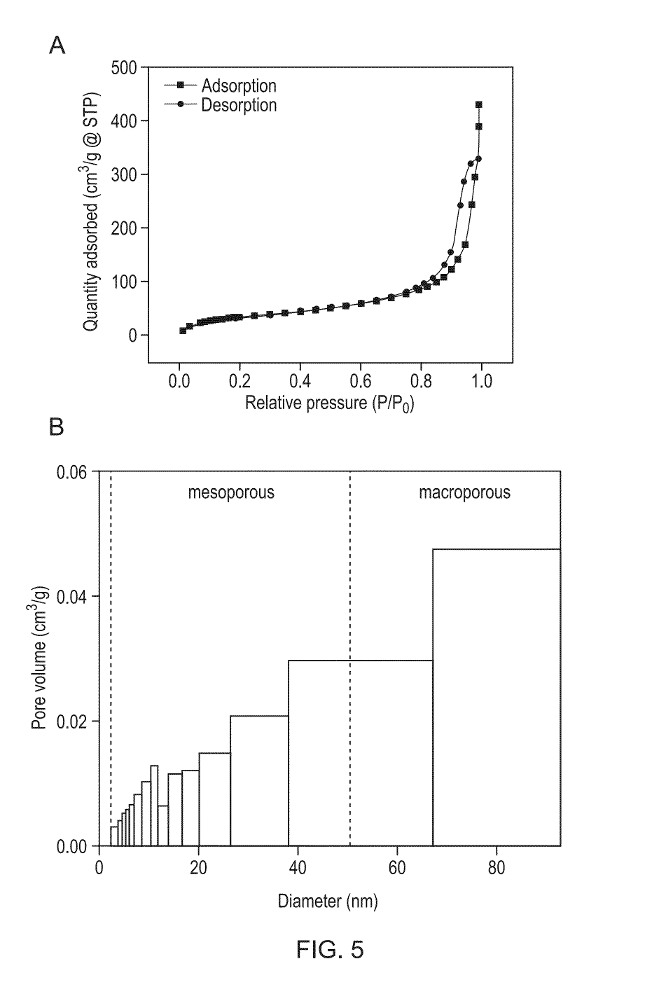

Carbon nanotubes (CNT) have been thoroughly researched as the material which could potentially breathe a new life to the realm of classically employed conductors. Theoretical current densities up to 4×10⁹ A/cm² (Reference 4) as well as room-temperature thermal conductivity of 3500 W/m·K (Reference 5) along the nanotube axis show that CNTs might one day outperform copper, one of the most intuitive choices for the applications that demand high thermal or electrical conductivity, by orders of magnitude. However, the way they are assembled on the macroscopic scale plays a pivotal role in the resulting electrical properties. Direct spinning from chemical vapor deposition (CVD) reactor (Reference 6) affords ultra-light and free-standing aerogel made of horizontally aligned CNTs. Because of the abundance of voids, the as-made material is porous (FIG. 5) with significant proportion of loose electrical connections and junctions. We now show that its resistivity reaches remarkably high values of 2.0-7.0×10⁻⁴ Ω·m and thus the material becomes a viable alternative to the metal wires contenders, giving a 700-fold improvement.

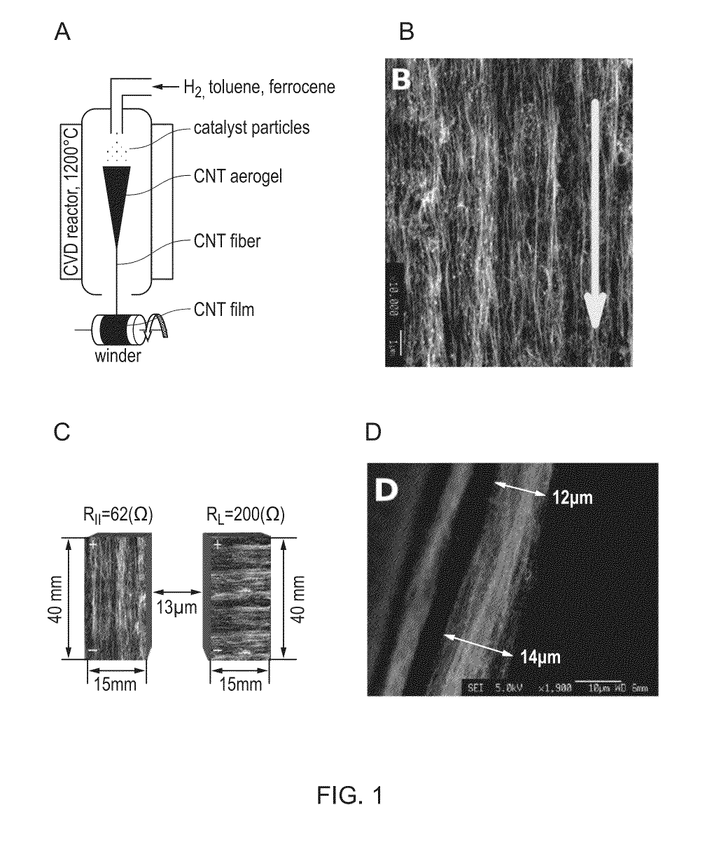

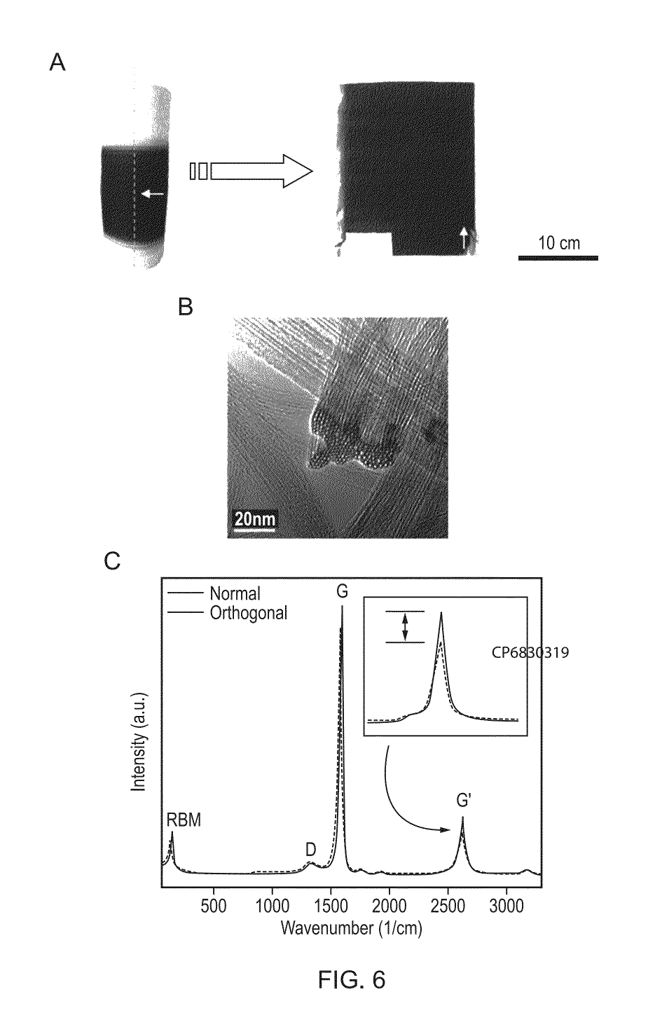

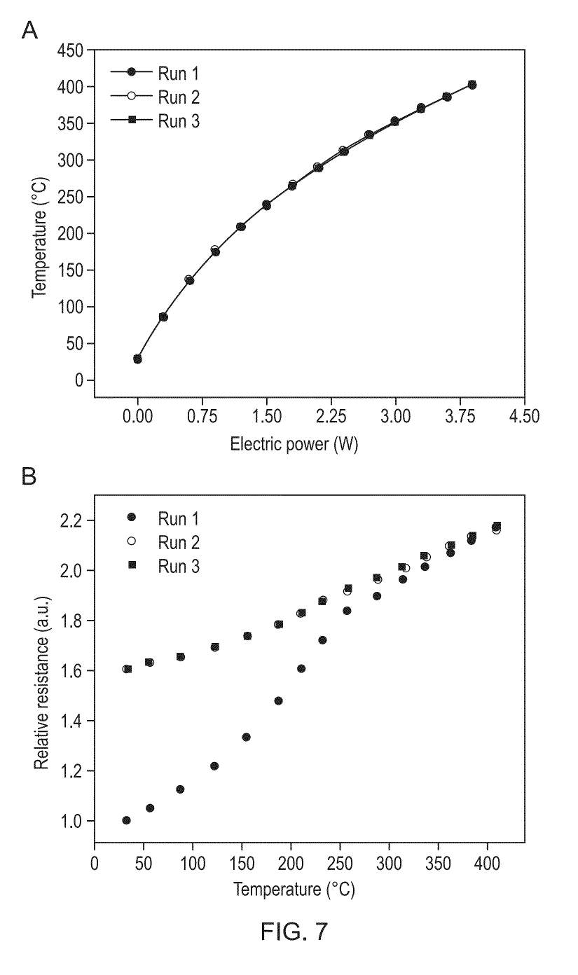

To turn a material widely envisioned as spectacular electric conductor into a highly resistive element, double-wall carbon nanotube (DWNT) films were directly spun from a CVD reactor as undensified yarns onto a reel until they produced a continuous roll of thin film (FIG. 1A, FIG. 6A). The synthesis was carried out at 1200° C. and employed toluene as the carbon source and ferrocene as the catalyst. Scanning electron microscopy reveals a very high degree in purity and horizontal alignment (FIG. 1B) of bundles (FIG. 6B). These conclusions are supported by the Raman spectra with particularly low D/G ratio equal to 0.05 (FIG. 6C). Moreover, the intensity is dependent on the orientation of laser polarization was is indicative of material's anisotropy (Reference 7). The samples through which the electric current passes across the alignment axis are on average three to four times as resistive as the normal specimens thought to be elevated by the increased number of electrical junctions in this direction (FIG. 1C). Our strategy was find the resistivity values of this material for both orientations of films and evaluate their performance as free-standing as well as quartz enclosed electric heaters. The material was found to be remarkably resistant. A head-on image of CNT film cross-section (FIG. 1D) enabled us to estimate the electrical resistivity to be between 2.0×10⁻⁴ Ω·m (measured with the alignment) and 7.0×10⁻⁴ Ω·m (orthogonal to the bundle orientation), which is higher by more than two orders of magnitude as for an isolated MWNT (Reference 8) or nichrome (Reference 3). Also, the CNT film shows a density of just 0.05 g/cm³ opposed to 8.30 g/cm³ for its aforementioned current technological rival (Reference 9). On that account, the conjunction of electrical resistivity and weight adds up to about 12,000,000% advantage when these two parameters are normalized. The same is valid even upon mechanical compression, when squeezed between two quartz surfaces, which provokes condensation and partial removal of voids separating CNT bundles, but just on the macroscale.

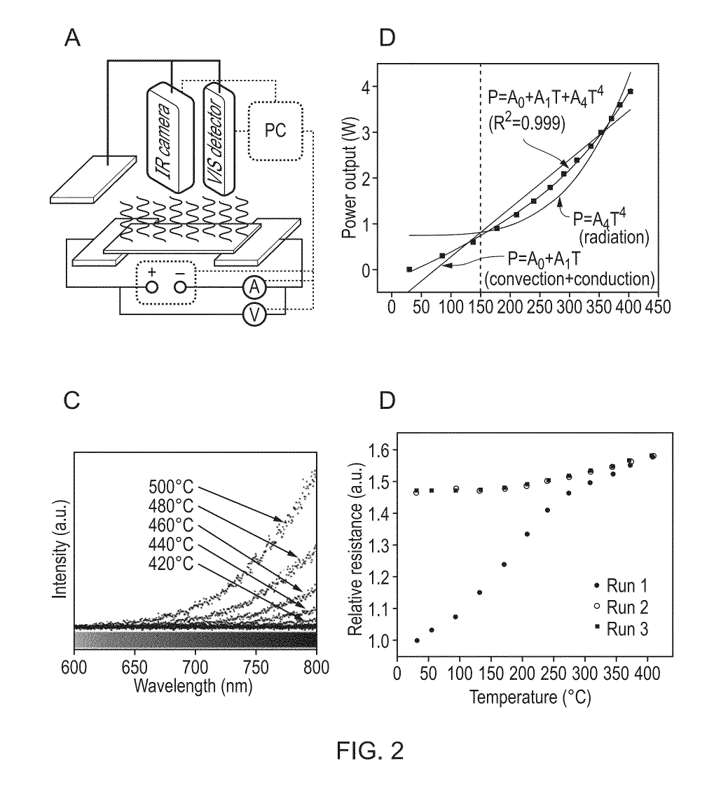

First, specimens were loaded onto custom-designed sample holders with a CNT film suspended in the middle and a DC bias voltage was applied whilst the surface temperature was monitored with a thermal camera (FIG. 2A). We observed a direct relationship between employed electric power and surface temperature what is in accordance with Joule heating law (FIG. S3A). To get a better understanding of the mechanism governing heat exchange, we treated surface temperature as variable assuming complete conversion of electric power into heat (FIG. 2B). Fitting revealed two regimes of heat evolution, the lower one being convection to air and conduction to the supporting quartz slides. Radiative emission starts to predominate at about 150° C. and at temperatures higher than 400° C. one can even see a very faint red glow of the hot surface. We examined that emission by using a low UV-visible light spectrometer and the CNT films confirmed to resemble the black body radiation as presented in the FIG. 2C. The individual emission peaks can be resolved, but their intensity at respective wavelengths vary stochastically as the time progresses. The sample is composed of a range of nanotube chiralities and diameters, each of which with a different set of allowed energy levels, giving numerous combinations between them of different probabilities.

According to our knowledge, this is the first attempt to get an inside view into electroluminescence from a macroscopic assembly of CNT bundles in air, a much more complex system to tackle than single nanotube studies in vacuum (Reference 10).

Thermal desorption of physically and chemically bound water and other dopants such as residual compounds from the synthesis stage result in the quasi-permanent increase of resistance of about 50% (FIG. 2D, S3B). The water reabsorption was reported to lower the resistance (Reference 11), but its contribution here was found insignificant in light of the heat-assisted removal the remaining species during the first run. Also, we did not observe wall exfoliation based on the same intensity of the Radial Breathing Mode (RBM) signal associated with the inner tubes (Reference 12) before and after the treatment up to the burning point. We rationalize it by the high degree of prisitnity of CNTs used throughout this study.

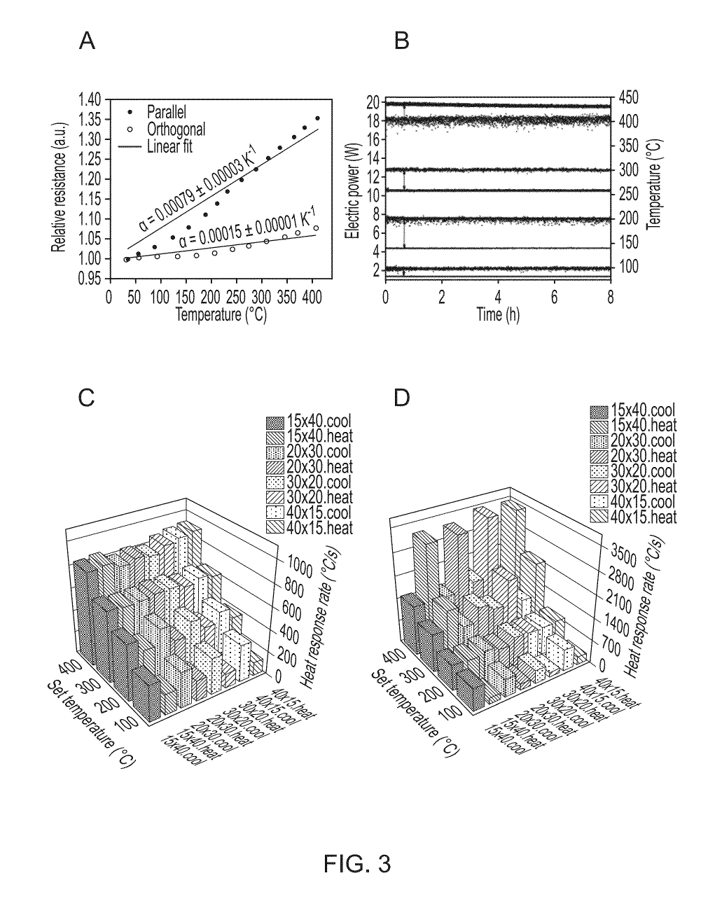

Reproducible behavior of the electrically pretreated films permitted us to evaluate the response of resistance to the temperature change in the r.t. —400° C. window of operation. They showed predominantly metallic character with low temperature coefficients of resistance (FIG. 3A) comparable to the value of nichrome 0.000225 K⁻¹ (Reference 13). The orthogonal sample appears to rely relatively more on the semiconductive mode of current conduction, what would illustrate why the resistance response linear fit, whose intercept was set to 1, deviates more from the equation (Reference 14) (negative temperature coefficient of resistance of a semiconductor opposes positive metal influence on this property).

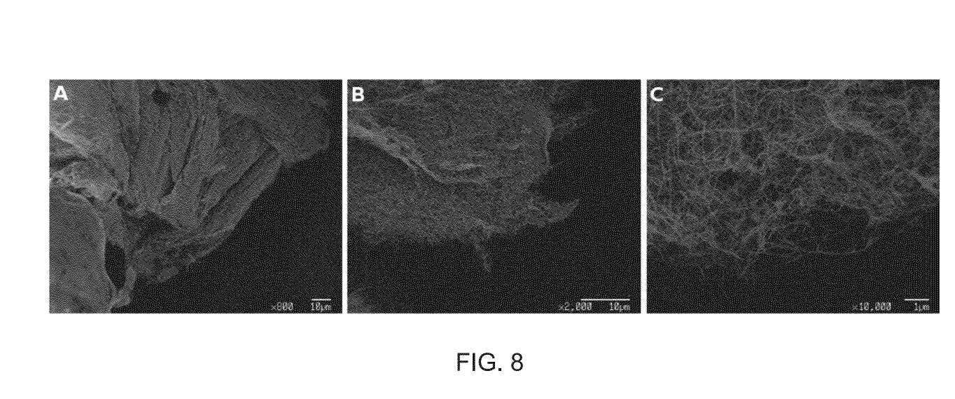

Moreover, the CNT films present the time-invariant performance as depicted in FIG. 3B. Raman spectra show virtually no change after each the treatment up to 400° C. in air confirming the absence of oxidation-driven deterioration in quality. The heaters set at the temperatures between 400° C. to 500° C. do not always survive an overnight test run and that may be justified by iron catalyst residue assisted oxidation, already active in these conditions (References 15,16). Once a glowing hot spot emerges, subsequent film scission (FIG. 8) across the sample takes place shortly and the electric circuit is broken There are scarce reports on nanocarbon based heating materials, but neither one of them is free-standing, anisotropic nor the operating temperatures exceed 160° C. (References 11,17-20).

We followed the study with subjecting the CNT film heaters to duty cycle tests and they were found completely durable to on-off switching for hundreds of times without any change to the properties. Same temperature is guaranteed every time for a given electrical power input. What is even more encouraging, is the speed of heat generation and its exchange with the surroundings. Due to a very specific low heat capacity (Reference 21) and porous nature, produced heat cannot be accumulated, so it is dissipated instantaneously. We discovered it takes about 0.5 s to heat up an orthogonally-aligned film from room temperature up to 400° C. (FIG. 3C). The thermal response of normally-aligned CNT films (FIG. 3D) is even faster reaching the terminal temperature in about 0.1 s, regardless of the sample aspect ratio in both scenarios. Heat sinking across the alignment axis i.e. in the radial direction is significantly smaller as compared to its value along the axis (Reference 22) and improves with increased degree of inter-bundle connections and entanglement, what makes the material more isotropic. Nevertheless, MWCNT films prepared from vertical arrays (Reference 20) afforded almost 50% lower performance in the same temperature range than our thermally-slower orthogonal specimens. High current density in the case of heating up normally-aligned specimens to 300° C. and 400° C. give rise to noteworthy rapid electrothermal response.

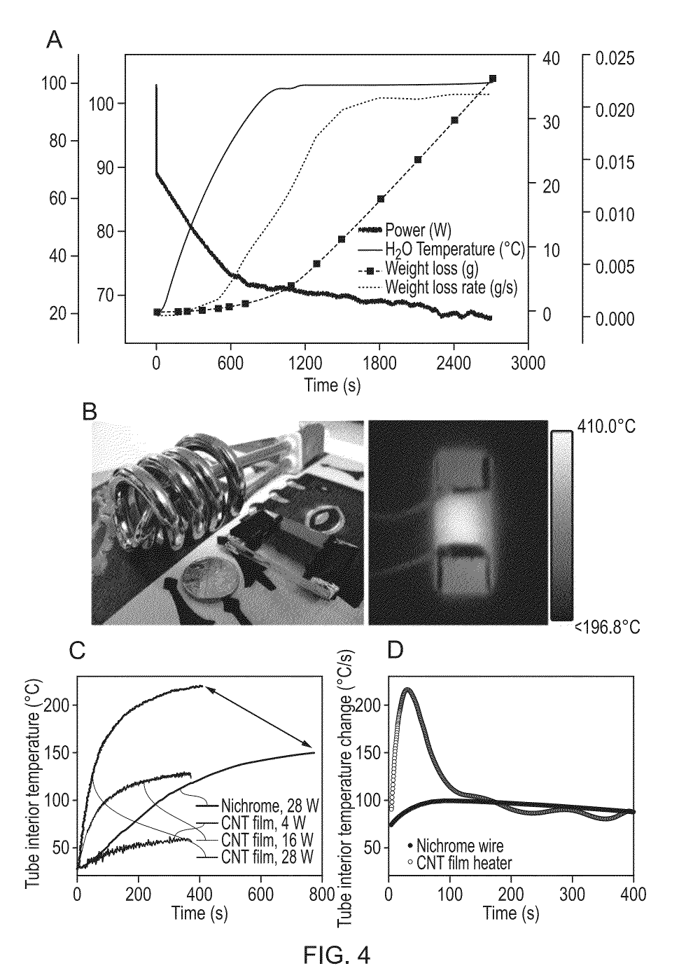

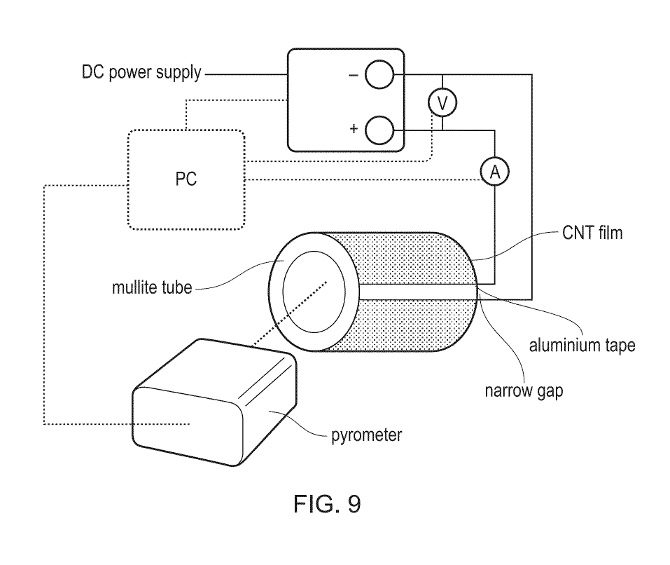

To confirm feasibility of the CNT film heaters we tested their performance in immersion and surface heating. For the first experiment, we chose water medium as a non-flammable candidate with relatively large heat capacity to assess the performance. The CNT films enclosed by quartz microscope slides presented stable operation over ten 45-minute long runs with slight temporary elevation of resistance because of the increase in temperature, as it might be expected. Once all the water is at 100° C. the system reaches steady-state with no further change of parameters (FIG. 4A). It is important to note that this tiny CNT heater arrives at this point faster than a commercial immersion heater we compared it with in the same conditions because there is no need to heat up a relatively big spiral enclosure made of metal first (FIG. 4B). Moreover, thermal conductivity of CNTs is superior to that of nichrome by two orders of magnitude (Reference 23). As in the case of immersion heaters, the efficiency of conversion of electric energy to heat is virtually equal to 100%. That was proven for the CNT film heaters by boiling liquid nitrogen in a dewar vessel and monitoring evaporation rate as a function of electric power input. In configurations like these, one can actually keep CNT filaments at much higher temperatures than 400° C. example shown because of the oxygen-free conditions. Finally, we employed the CNT films as a true heating layer which could be deposited onto any desired site. Mullite tube is often employed as a heat resistant vessel in many high temperature operations hence we compared how it would be heated up as we wind it around with CNT films or a nichrome strip reference of the same dimensions taken out from an industrial heating tape (FIG. 9). The CNT films rendered reproducible behavior and very fast heating rates of the inner side of the mullite tube outperforming nichrome whilst being faster even at lower wattage (FIGS. 4C and D). Nichrome strips are more rigid and not as adhesive and flexible as carbon nanotube filaments, thus they cannot ensure good contact with the substrate. Heating is less localized and more prone to convective losses. The advantage of the CNT film heaters is intensified by their emissivity close to unity (Reference 24) as well as uncommonly small heat capacity per unit area (Reference 21), what makes the heating process unconstrained by thermal inertia taking the material one step beyond the current solutions. Our CNT-covered mullite tube can therefore be used as highly-efficient furnaces and reactors without significant further modification.

Materials and Methods:

Carbon nanotube film (areal density of 10⁻⁵ g/cm³) were directly spun as yarns from the decomposition of toluene catalyzed by ferrocene in hydrogen atmosphere in a CVD vertical reactor kept at 1200° C. They were continuously deposited onto a rotating winder that had been equipped with a polycarbonate sheet. Once a seamless roll of material was prepared it was cut open to yield an A4 planar sheet of CNT film. Then, the specimens were cut out along and across the alignment direction with a razor blade and peeled off easily from the polycarbonate sheet. To compensate for a possibility of small variation in thickness we used relative resistance (Rᵢ was always divided by R₀ measured with a multimeter at room temperature) throughout the study.

The aforementioned films were used for:
Free-standing measurements—placed onto a custom-designed sample holders made of quartz microscope slides and aluminum tape on top of them. Silver conductive paint was used between CNT film ends and aluminum tape surface to assure no contact resistance because it perfuses the material easily.
Water boiling—sandwiched between four quartz microscope slide. Electrodes were connected to aluminum foil strips terminals as shown in the FIG. 4B, which passes the current further along the CNT filament. Mechanical connection was used instead of silver conductive paint because of its unsuitability in water medium.
Mullite tube heating—wound around a mullite tube. Aluminum tape and silver paint was used at the ends similarly as in the first case.

DC power supply (TTi QL564P) was connected to the terminals with crocodile clips. It was controlled by a specially designed PID application, which can keep the magnitude of electric power constant, unless constant bias voltage measurements were more suitable (the measurements of resistance change in time, for instance). To make sure we record true values of electrical properties, two on-line multimeters (Precision gold, N56FU) recorded bias voltage and current, respectively, and passed the data onto a PC in real-time.

Surface temperature was recorded by a focused thermal camera (Flir SC640) in the case of free-standing measurements, but pyrometer (Impact 140) was found more apropriate to measure the temperature of the inner side of a mullite tube because of its curvature. Additionally, heat response speed was evaluated on a Flir SC3000 because it offers 750 Hz acquisition.

Finally, emission properties were analyzed by an UV-Vis spectrometer (Princeton Instruments ICCD Kinetic Spectrometer) equipped with a CCD detector (water cooled by a Peltier device to −25° with simultaneous removal of moisture by dry N₂), which operated in a darkroom.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

### REFERENCES AND NOTES

1. J.-W. Jiang, J.-S. Wang, Joule heating and thermoelectric properties in short single-walled carbon nanotubes: Electron-phonon interaction effect. J. Appl. Phys. 110, 124319 (2011).
2. C. Rutherglen, P. J. Burke, Nano-Electromagnetics: Circuit and Electromagnetic Properties of Carbon Nanotubes. Small 5, 884-906 (2009).
3. M. K. Sinha, S. K. Mukherjee, B. Pathak, R. K. Paul, P. K. Barhai, Effect of deposition process parameters on resistivity of metal and alloy films deposited using anodic vacuum arc technique. Thin Solid Films 515, 1753-1757 (2006).
4. S. Hong, S. Myung, Nanotube Electronics: A flexible approach to mobility. Nature Nanotech. 2, 207-208 (2007).
5. E. Pop, D. Mann, Q. Wang, K. Goodson, H. Dai, Thermal conductance of an individual single-wall carbon nanotube above room temperature. Nano Lett. 6, 96-100 (2005).
6. Y.-L. Li, I. A. Kinloch, A. H Windle, Direct spinning of carbon nanotube fibers from chemical vapor deposition synthesis. Science 304, 276-278 (2004).
7. P. Liu, L. Liu, Y. Zhang, Alignment characterization of single-wall carbon nanotubes by Raman scattering. Phys. Lett. A 313, 302-306 (2003).
8. T. D. Yuzvinsky, W. Mickelson, S. Aloni, S. L. Konsek, A. M. Fennimore, G. E. Begtrup, A. Kis, B. C. Regan, A. Zettla, Imaging the life story of nanotube devices. Appl. Phys. Lett. 87, 083103 (2005).
9. D. J. Sypeck, H. N. G. Wadley, Multifunctional microtruss laminates: Textile synthesis and properties. J. Mater. Res. 16, 890-897 (2001).
10. D. Mann, Y. K. Kato, A. Kinkhabwala, E. Pop, J. Cao, X. Wang, L. Zhang, Q. Wang, J. Guo, H. Dai, Electrically driven thermal light emission from individual single-walled carbon nanotubes. Nature Nanotech. 2, 33-38(2007).
11. D. Kim, H.-C. Lee, J. Y. Woo, C.-S. Han, Thermal behavior of Transparent Film Heaters Made of Single-Walled Carbon Nanotubes. J. Phys. Chem. C 114, 5817-5821 (2010).
12. W. Ren, F. Li, J. Chen, S. Bai, H.-M. Cheng, Morphology, diameter distribution and Raman scattering measurements of double-walled carbon nanotubes synthesized by catalytic decomposition of methane. Chem. Phys. Lett. 359, 196-202 (2002).
13. C. L. Au, M. A. Jackson, W. A. Anderson, Structural and Electrical Properties of Stable Ni/Cr Thin Films. J. Electron. Mater. 16, 301-306 (1987).
14. Rᵢ/R₀=α(Tᵢ−T₀)+1
   Where R₀—electrical resistance at temperature T₀, Rᵢ—electrical resistance at temperature Tᵢ (Ω and ° C., respectively), α—the temperature coefficient of resistance (K⁻¹)
15. M. Kasper, K. Siegmann, The influence of ferrocene on PAH synthesis in acetylene and methane diffusion flames. Combust. Sci. Technol. 140, 333-350 (1998).
16. I. W. Chiang, B. E. Brinson, A. Y. Huang, P. A. Willis, M. J. Bronikowski, J. L. Margrave, R. E. Smalley, R. H. Hauge, Purification and Characterization of Single-Wall Carbon Nanotubes (SWNTs) Obtained from the Gas-Phase Decomposition of CO (HiPco Process). J. Phys. Chem. B 105, 8297-8301 (2001).
17. Z. P. Wu, J. N. Wang, Preparation of large-area double-walled carbon nanotube films and application as film heater. Physica E 42, 77-81 (2009).
18. H.-S. Jang, S. K. Joon, S. H. Nahm, The manufacture of transparent film heater by spinning multi-walled carbon nanotubes. Carbon 49, 111-116 (2011).
19. D. Sui, Y. Huang, L. Huang, J. Liang, Y. Ma, Y. Chen, Flexible and Transparent Electrothermal Film Heaters Based on Graphene Materials. Small 7, 3186-3192 (2011).
20. H. Im, E. Y., Jang, A. Choi, W. J. Kim, T. J. Kang, Y. W. Park, Y. H. Kim, Enhancement of Heating Performance of Carbon Nanotube Sheet with Granular Metal. ACS Appl. Mater. Interfaces 4, 2338-2342 (2012).
21. P. Liu, L. Liu, K. Jiang, S. Fan, Carbon-Nanotube-Film Microheater on a Polyethylene Terephthalate Substrate and Its Application in Thermochromic Displays. Small 7, 732-736 (2010).
22. S. Sinha, S. Barjami, G. Iannacchione, A. Schwab, G. Muench, Off-axis thermal properties of carbon nanotube films. J. Nanopart. Res. 7, 651-657 (2005).
23. R. Endo, M. Shima, M. Susa, Thermal-Conductivity Measurements and Predictions for Ni—Cr Solid Solution Alloys. Int. J. Thermophys. 31, 1991-2003(2010).
24. K. Mizuno, J. Ishii, H. Kishida, Y. Hayamizu, S. Yasuda, D. N. Futaba, M. Yumura, K. Hata, A black body absorber from vertically aligned single-walled carbon nanotubes. Proc. Natl. Acad. Sci. U.S.A. 106, 6044-6047 (2009).

1. A heater element for generating heat via Joule heating, the heater element having a layer of aligned carbon nanotubes and electrical terminals located to allow, in use, an electrical current to be passed along the layer of aligned carbon nanotubes, wherein the direction of the electrical current in use is substantially perpendicular to the alignment direction of the aligned carbon nanotubes.

2. The heater element according to claim 1, wherein the heater element is flexible.

3. The heater element according to claim 1, wherein the heater element is provided in a roll form, allowing the heater element to be unwound from the roll and conformed by a user to a specific task.

4. The heater element according to claim 1, wherein the layer is formed mainly from the group selected from: single wall carbon nanotubes (SWNTs), double wall carbon nanotubes (DWNTs) and multi wall carbon nanotubes (MWNTs) and combinations thereof.

5. The heater element according to claim 1, wherein the ratio between the resistivity perpendicular to the alignment direction and the resistivity parallel to the alignment direction is at least 2.

6. The heater element according to claim 1, wherein the density of the carbon nanotube layer is 0.1 gcm⁻³ or less.

7. The heater element according to claim 1, wherein the temperature coefficient of resistance between 50-300° C. is 0.001 K⁻¹ or less.

8. A method of generating heat comprising:
providing a heater element having a layer of aligned carbon nanotubes; and
passing an electrical current along the layer of aligned carbon nanotubes to generate heat via Joule heating,
wherein the direction of the electrical current is substantially perpendicular to the alignment direction of the aligned carbon nanotubes.

9. A heater comprising:
a heating element for generating heat via Joule heating, the heater element having a layer of aligned carbon nanotubes and electrical terminals located to allow, in use, an electrical current to be passed along the layer of aligned carbon nanotubes, wherein the direction of the electrical current in use is substantially perpendicular to the alignment direction of the aligned carbon nanotubes; and
power supply means for delivering an electrical current between the electrical terminals.

10. A method of manufacturing a heater element for generating heat via Joule heating, the heater element having a layer of aligned carbon nanotubes and electrical terminals located to allow, in use, an electrical current to be passed along the layer of aligned carbon nanotubes, wherein the direction of the electrical current in use is substantially perpendicular to the alignment direction of the aligned carbon nanotubes, the method comprising:
growing carbon nanotubes in a CVD reactor; and
forming the layer of aligned carbon nanotubes by pulling a carbon nanotube yarn from the CVD reactor, the alignment direction being the direction of pulling from the CVD reactor.

11. The method according to claim 10, wherein the electrical terminals are affixed to the CNT layer in order to define the direction of the electrical current between them as substantially perpendicular to the CNT alignment direction.

12. The method according to claim 11, wherein the step of affixing the electrical terminals is done separately to the step of forming the CNT layer.
